(19) United States
(12) Patent Application Publication
(10) Pub. No.: US 2026/0054297 A1
(43) Pub. Date: Feb. 26, 2026

(54) Carpet Cleaning Device

(71) Applicant: Eric McInnis, Prince Williams (CA)

(72) Inventor: Eric McInnis, Prince Williams (CA)

(21) Appl. No.: 18/814,539

(22) Filed: Aug. 25, 2024

(51) Int. Cl. B08B 7/02; A47L 11/40

(52) U.S. Cl. CPC B08B 7/02; A47L 11/40

(57) ABSTRACT

A carpet cleaning device for percussively vibrating against carpeted surfaces to dislodge debris includes an oscillating multi-tool having an accessory attachment mechanism. An accessory is releasably couplable to the oscillating multi-tool. The accessory is positionable against a carpet material wherein the oscillating multi-tool oscillates the accessory and the accessory percussively vibrates against the carpet material to dislodge debris from the carpet material. The accessory includes a plate that is releasably couplable to the accessory attachment mechanism. A lobe is coupled to the plate. The lobe has a top side and a bottom side. The bottom side is convexly arcuate between opposing lateral ends of the top side wherein the bottom side is designed to be positioned against the carpet material to dislodge debris from the carpet material. The lobe comprises a rigid material wherein the lobe is designed to percussively vibrate against the carpet material to dislodge debris.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to surface cleaning tools and more particularly pertains to a new surface cleaning tool for percussively vibrating against carpeted surfaces to dislodge debris.

### (2) Description of Related Art Including Information Disclosed Under 37 CFR 1.97 and 1.98

The prior art relates to surface cleaning tools. More specifically, the prior art relates to vacuums and other tools used to clean carpeted surfaces. Such devices typically use suction forces to pull debris up from the carpeted surfaces into a collection tank or a vacuum bag. However, such devices have limited efficacy when debris is deeply embedded into the fibers of the carpeted surfaces. For example, when cleaning rugs, people typically need to lift the rugs from the floor and hit the rugs to dislodge deeply embedded debris. Thus, there is a need in the art for a tool that can be used to create percussive vibrations against carpeted surfaces to dislodge and remove debris that is deeply embedded into the fibers of the carpeted surface.

### BRIEF SUMMARY OF THE INVENTION

An embodiment of the disclosure meets the needs presented above by generally comprising an oscillating multi-tool having an accessory attachment mechanism. An accessory is releasably couplable to the oscillating multi-tool. The accessory is positionable against a carpet material wherein the oscillating multi-tool is configured to oscillate the accessory whereby the accessory is configured to percussively vibrate against the carpet material to dislodge debris from the carpet material. The accessory includes a plate that is releasably couplable to the accessory attachment mechanism. A lobe is coupled to the plate. The lobe has a top side and a bottom side. The bottom side is convexly arcuate between opposing lateral ends of the top side wherein the bottom side is configured to be positioned against the carpet material to dislodge debris from the carpet material. The lobe comprises a rigid material wherein the lobe is configured to percussively vibrate against the carpet material to dislodge debris.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a carpet cleaning device according to an embodiment of the disclosure.

FIG. 2 is a top exploded view of an embodiment of the disclosure.

FIG. 3 is an in-use view of an embodiment of the disclosure.

FIG. 4 is a front view of an embodiment of the disclosure.

FIG. 5 is a back view of an embodiment of the disclosure.

FIG. 6 is a side view of an embodiment of the disclosure.

FIG. 7 is an isometric view of an embodiment of the disclosure.

FIG. 8 is a front view of an embodiment of the disclosure.

FIG. 9 is a bottom view of an embodiment of the disclosure.

### DETAILED DESCRIPTION OF THE INVENTION

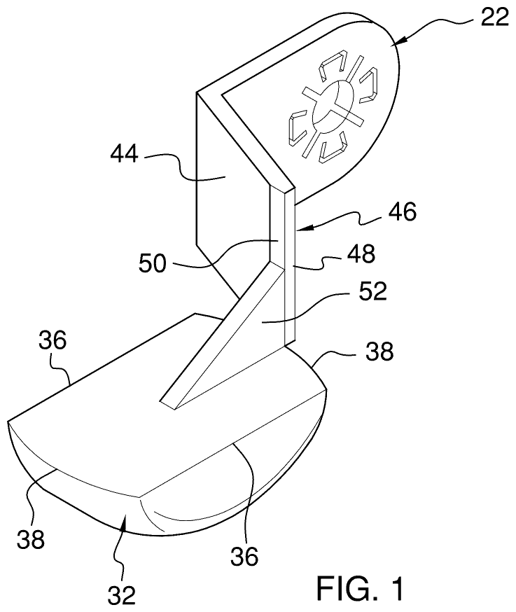

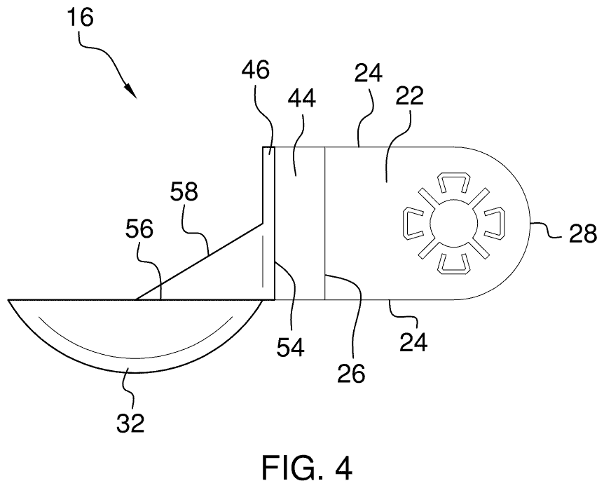

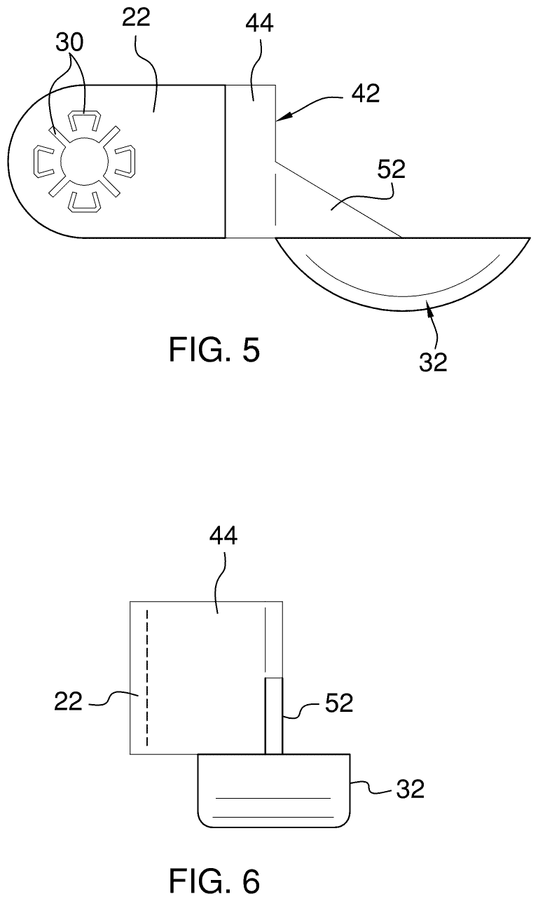

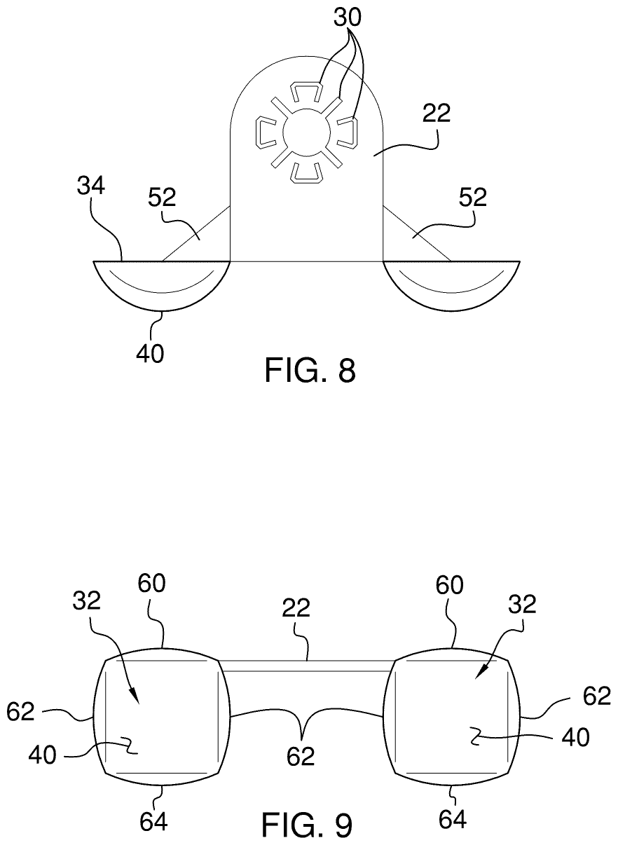

With reference now to the drawings, and in particular to FIGS. 1 through 9 thereof, a new surface cleaning tool embodying the principles and concepts of an embodiment of the disclosure and generally designated by the reference numeral 10 will be described.

As best illustrated in FIGS. 1 through 9, the carpet cleaning device 10 generally comprises an oscillating multi-tool 12 that has an accessory attachment mechanism 14. An accessory 16 is releasably couplable to the oscillating multi-tool 12. The accessory 16 is positionable against a carpet material 18 wherein the oscillating multi-tool 12 is configured to oscillate the accessory 16 whereby the accessory 16 is configured to percussively vibrate against the carpet material 18 to dislodge debris 20 from the carpet material 18.

The accessory 16 may include a plate 22 that is releasably couplable to the accessory attachment mechanism 14. The plate 22 may be planar. The plate 22 may include a pair of opposing plate lateral edges 24 that are parallel with each other. A forward edge 26 may be coupled to and extend between the pair of opposing plate lateral edges 24. The forward edge 26 may be perpendicular to the pair of opposing plate lateral edges 24. A rear edge 28 may be coupled to and extend between the pair of opposing plate lateral edges 24. The rear edge 28 is generally distally positioned on each of the pair of opposing plate lateral edges 24 relative to the forward edge 26. The rear edge 28 may be convexly arcuate between the pair of opposing plate lateral edges 24.

A plurality of apertures 30 may extend through the plate 22. The plurality of apertures 30 may be positioned adjacent to the rear edge 28 of the plate 22. The plurality of apertures 30 generally have a shape and a configuration that is configured to complement the accessory attachment mechanism 14 wherein the plurality of apertures 30 are configured to facilitate coupling the plate 22 to the accessory attachment mechanism 14. The exact number, shape, size, and orientation in which the plurality of apertures 30 are configured may vary based on the accessory attachment mechanism 14 of the oscillating multi-tool 12 to which the accessory 16 is coupled. For example, different models of the oscillating multi-tool 12 may have variations in the configuration of the accessory attachment mechanism 14. The accessory 16 described in this specification is contemplated for use with any oscillating multi-tool 12.

A lobe 32 may be coupled to the plate 22. The lobe 32 may comprise a rigid material wherein the lobe 32 is configured to percussively vibrate against the carpet material 18 to dislodge debris 20. The rigid material may include, for example, metals, alloys such as mild steel, and plastics. Other materials are also contemplated.

The lobe 32 generally includes a top side 34. The top side 34 may be perpendicular to the plate 22. The top side 34 may have a pair of straight edges 36 and a pair of arcuate edges 38. The pair of straight edges 36 may be parallel to each other. The pair of arcuate edges 38 may be convexly arcuate between the pair of straight edges 36. The top side 34 may be planar.

The lobe 32 also generally includes a bottom side 40 that is coupled to and extends from the top side 34. For example, the bottom side 40 may be convexly arcuate between the pair of straight edges 36 of the top side 34. The bottom side 40 is generally configured to be positioned against the carpet material 18 to dislodge debris 20 from the carpet material 18.

A fin 42 may couple the lobe 32 to the plate 22. The fin 42 may be angled to extend outwardly from the plate 22 and downwardly to the top side 34 of the lobe 32. In such embodiments, the top side 34 of the lobe 32 is vertically spaced from the plate 22 by the fin 42.

For example, the fin 42 may include a tongue 44 that is angled to extend outwardly from the forward edge 26 of the plate 22 and downwardly toward the lobe 32. The tongue 44 may have a lower end 46 with a first surface 48 and a second surface 50. The first surface 48 may be beveled. The second surface 50 may be squared.

A rib 52 may be coupled to the tongue 44. The rib 52 may extend outwardly from the lower end 46 of the tongue 44 to the top side 34 of the lobe 32. The rib 52 may be perpendicular to the top side 34 of the lobe 32. The rib 52 may include a rib lateral edge 54 that is positioned on the first surface 48 of the lower end 46 of the tongue 44. A rib lower edge 56 may be coupled to and extend outwardly from the rib lateral edge 54. The rib lower edge 56 may be coupled to the top side 34 of the lobe 32 wherein the rib 52 extends upwardly from the top side 34 of the lobe 32. The rib lower edge 56 may be perpendicular to the rib lateral edge 54. A rib upper edge 58 that is coupled to and extends from the rib lateral edge 54. The rib upper edge 58 may be angled to extend outwardly from the rib lateral edge 54 and downwardly to intersect with the rib lower edge 56 on the top side 34 of the lobe 32 wherein the rib 52 defines a triangular shape.

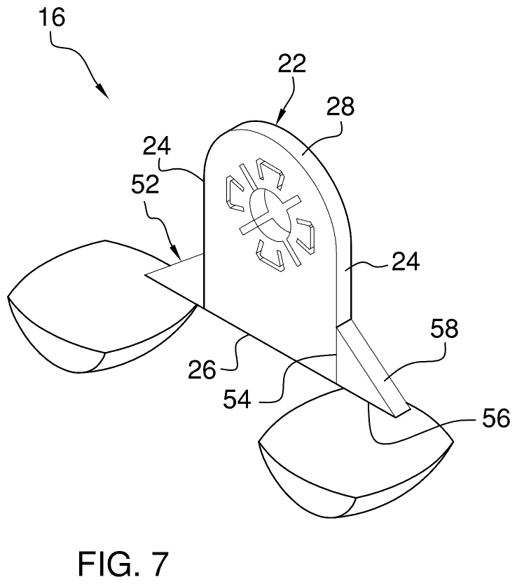

In embodiments according to FIGS. 7-9, the accessory 16 may include a pair of lobes 32 that are coupled to the plate 22. Each lobe of the pair of lobes 32 may be generally constructed according to the description of the single lobe 32 above. Alternatively, the top side 34 of each lobe of the pair of lobes 32 may have a front edge 60, a pair of side edges 62, and a back edge 64. The front edge 60 may be convexly arcuate between the pair of side edges 62. Each side edge of the pair of side edges 62 may be convexly arcuate between the front edge 60 and the back edge 64. The back edge 64 may be convexly arcuate between the pair of side edges 62. The bottom side 40 may be convexly arcuate between opposing lateral ends of the top side 34, like the bottom side 40 of the single lobe. For example, the bottom side 40 may be convexly arcuate between the pair of side edges 62 of the top side 34.

Such embodiments may also include a pair of ribs 52 coupling each lobe 32 of the pair of lobes 32 to the plate 22. The pair of ribs 52 may be coplanar with the plate 22. Each rib of the pair of ribs 52 may be angled to extend outwardly from the plate 22 and downwardly to the top side 34 of a respective lobe 32 of the pair of lobes 32. Accordingly, the top side 34 of the respective lobe 32 is generally vertically spaced from the plate 22. Each rib of the pair of ribs 52 may be positioned on a respective opposing plate lateral edge of the pair of opposing plate lateral edges 24 of the plate 22 wherein the pair of lobes 32 are spaced from each other across the plate 22. Each rib of the pair of ribs 52 may be perpendicular to the top side 34 of the respective lobe 32 of the pair of lobes 32.

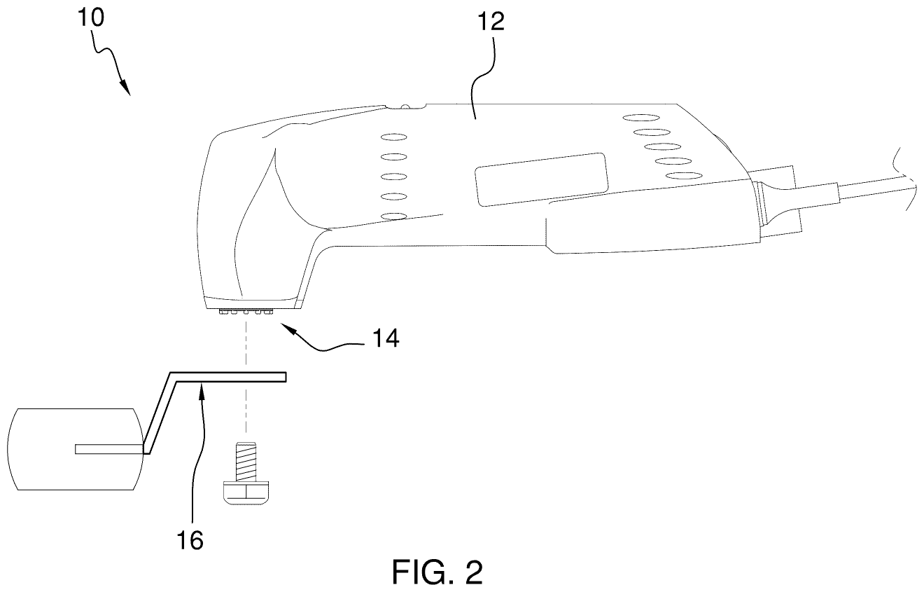

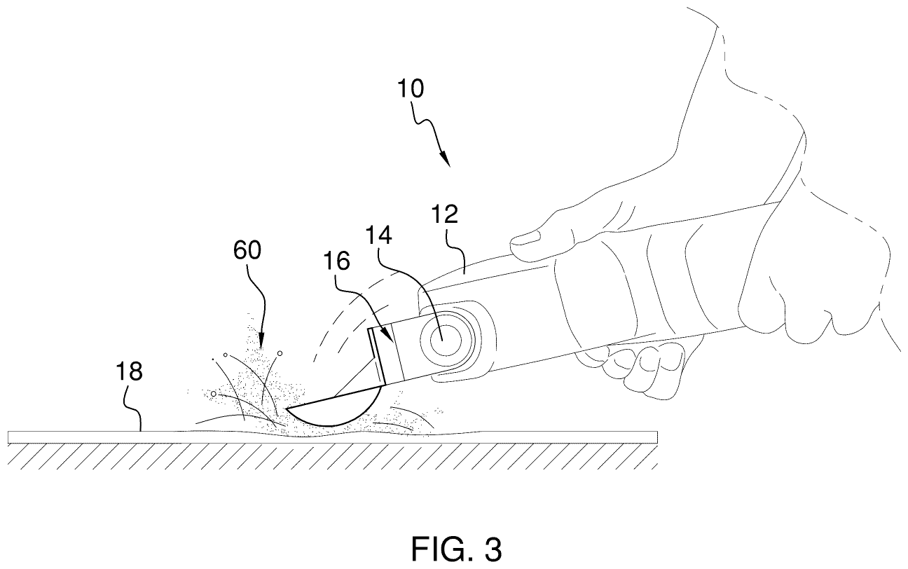

In use, the carpet cleaning device 10 can be used to dislodge debris 20 from the carpet material 18. For example, the carpet material 18 may include an automotive floor mat, or a carpeted floor. The attachment can be releasably coupled to the accessory attachment mechanism 14 of the oscillating multi-tool 12, as shown in FIG. 2. The oscillating multi-tool 12 can then be held over the carpet material 18. In FIG. 3, the user is holding the oscillating multi-tool 12 sideways, such that the bottom side 40 of the lobe 32 is in physical contact with the carpet material 18. When the oscillating multi-tool 12 is turned on, the accessory 16 will percussively vibrate against the carpet material 18 to dislodge debris 20 that was previously embedded within the fibers of the carpet material 18.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A carpet cleaning system comprising:
an oscillating multi-tool having an accessory attachment mechanism;
an accessory being releasably couplable to the oscillating multi-tool, the accessory being positionable against a carpet material wherein the oscillating multi-tool is configured to oscillate the accessory whereby the accessory is configured to percussively vibrate against the carpet material to dislodge debris from the carpet material, the accessory including:
a plate being releasably couplable to the accessory attachment mechanism; and
a lobe being coupled to the plate, the lobe having a top side and a bottom side, the bottom side being convexly arcuate between opposing lateral ends of the top side wherein the bottom side is configured to be positioned against the carpet material to dislodge debris from the carpet material, the lobe comprising a rigid material wherein the lobe is configured to percussively vibrate against the carpet material to dislodge debris.

2. The carpet cleaning system of claim 1, the plate further comprising:
a pair of opposing plate lateral edges being parallel with each other;
a forward edge being coupled to and extending between the pair of opposing plate lateral edges; and
a rear edge being coupled to and extending between the pair of opposing plate lateral edges.

3. The carpet cleaning system of claim 2, wherein the forward edge of the plate is perpendicular to the pair of opposing plate lateral edges of the plate.

4. The carpet cleaning system of claim 2, wherein the rear edge of the plate is convexly arcuate between the pair of opposing plate lateral edges of the plate.

5. The carpet cleaning system of claim 1, the accessory further comprising a plurality of apertures extending through the plate, the plurality of apertures having a shape being configured to complement the accessory attachment mechanism wherein the plurality of apertures are configured to facilitate coupling the plate to the accessory attachment mechanism.

6. The carpet cleaning system of claim 1, wherein the top side of the lobe is perpendicular to the plate.

7. The carpet cleaning system of claim 1, wherein the top side of the lobe is planar.

8. The carpet cleaning system of claim 1, the top side of the lobe further comprising a pair of straight edges and a pair of arcuate edges.
h. The carpet cleaning system of claim 8, wherein the pair of straight edges of the top side of the lobe are parallel to each other.

9. The carpet cleaning system of claim 8, wherein the pair of arcuate edges of the top side of the lobe are convexly arcuate between the pair of straight edges.

10. The carpet cleaning system of claim 1, the lobe further comprising a pair of lobes being spaced from each other across the plate.

11. The carpet cleaning system of claim 10, the attachment further comprising a pair of ribs, each rib of the pair of ribs coupling a respective lobe of the pair of lobes to the plate.

12. The carpet cleaning system of claim 11, wherein each rib of the pair of ribs is angled to extend outwardly from the plate and downwardly to the top side of the respective lobe of the pair of lobes wherein the top side of the respective lobe is vertically spaced from the plate.

13. The carpet cleaning system of claim 1, further comprising a fin coupling the lobe to the plate, the fin being angled to extend outwardly from the plate and downwardly to the top side of the lobe wherein the top side of the lobe is vertically spaced from the plate.

14. The carpet cleaning system of claim 13, the fin further comprising:
a tongue being angled to extend outwardly from a forward edge of the plate and downwardly toward the lobe; and
a rib being coupled to the tongue, the rib extending outwardly from the tongue to the top side of the lobe, the rib being perpendicular to the top side of the lobe.

15. The carpet cleaning system of claim 14, the rib further comprising:
a rib lateral edge being positioned on the tongue;
a rib lower edge being coupled to and extending outwardly from the rib lateral edge, the rib lower edge being coupled to the top side of the lobe wherein the rib extends upwardly from the top side of the lobe; and
a rib upper edge being coupled to and extending from the rib lateral edge, the rib upper edge being angled to extend outwardly from the rib lateral edge and downwardly to intersect with the rib lower edge on the top side of the lobe wherein the rib defines a triangular shape.

16. A carpet cleaning system comprising:
an oscillating multi-tool having an accessory attachment mechanism;
an accessory being releasably couplable to the oscillating multi-tool, the accessory being positionable against a carpet material wherein the oscillating multi-tool is configured to oscillate the accessory whereby the accessory is configured to percussively vibrate against the carpet material to dislodge debris from the carpet material, the accessory including:
a plate being releasably couplable to the accessory attachment mechanism, the plate being planar, the plate including:
a pair of opposing plate lateral edges being parallel with each other;
a forward edge being coupled to and extending between the pair of opposing plate lateral edges, the forward edge being perpendicular to the pair of opposing plate lateral edges; and
a rear edge being coupled to and extending between the pair of opposing plate lateral edges, the rear edge being distally positioned on each of the pair of opposing plate lateral edges relative to the forward edge, the rear edge being convexly arcuate between the pair of opposing plate lateral edges;
a plurality of apertures extending through the plate, the plurality of apertures having a shape being configured to complement the accessory attachment mechanism wherein the plurality of apertures are configured to facilitate coupling the plate to the accessory attachment mechanism, the plurality of apertures being positioned adjacent to the rear edge of the plate;
a lobe being coupled to the plate, the lobe comprising a rigid material wherein the lobe is configured to percussively vibrate against the carpet material to dislodge debris, the lobe including:
a top side being perpendicular to the plate, the top side having a pair of straight edges and a pair of arcuate edges, the pair of straight edges being parallel to each other, the pair of arcuate edges being convexly arcuate between the pair of straight edges, the top side being planar;
a bottom side being coupled to and extending from the top side, the bottom side being convexly arcuate between the pair of straight edges of the top side wherein the bottom side is configured to be positioned against the carpet material to dislodge debris from the carpet material;
a fin coupling the lobe to the plate, the fin being angled to extend outwardly from the plate and downwardly to the top side of the lobe wherein the top side of the lobe is vertically spaced from the plate, the fin including:
a tongue being angled to extend outwardly from the forward edge of the plate and downwardly toward the lobe, the tongue having a lower end with a first surface and a second surface, the first surface being beveled, the second surface being squared; and
a rib being coupled to the tongue, the rib extending outwardly from the lower end of the tongue to the top side of the lobe, the rib being perpendicular to the top side of the lobe, the rib including:
a rib lateral edge being positioned on the first surface of the lower end of the tongue;
a rib lower edge being coupled to and extending outwardly from the rib lateral edge, the rib lower edge being coupled to the top side of the lobe wherein the rib extends upwardly from the top side of the lobe, the rib lower edge being perpendicular to the rib lateral edge; and
a rib upper edge being coupled to and extending from the rib lateral edge, the rib upper edge being angled to extend outwardly from the rib lateral edge and downwardly to intersect with the rib lower edge on the top side of the lobe wherein the rib defines a triangular shape.

17. A carpet cleaning system comprising:
an oscillating multi-tool having an accessory attachment mechanism;
an accessory being releasably couplable to the oscillating multi-tool, the accessory being positionable against a carpet material wherein the oscillating multi-tool is configured to oscillate the accessory whereby the accessory is configured to percussively vibrate against the carpet material to dislodge debris from the carpet material, the accessory including:
a plate being releasably couplable to the accessory attachment mechanism, the plate being planar, the plate including:
a pair of opposing plate lateral edges being parallel with each other;
a forward edge being coupled to and extending between the pair of opposing plate lateral edges, the forward edge being perpendicular to the pair of opposing plate lateral edges; and
a rear edge being coupled to and extending between the pair of opposing plate lateral edges, the rear edge being distally positioned on each of the pair of opposing plate lateral edges relative to the forward edge, the rear edge being convexly arcuate between the pair of opposing plate lateral edges;
a plurality of apertures extending through the plate, the plurality of apertures having a shape being configured to complement the accessory attachment mechanism wherein the plurality of apertures are configured to facilitate coupling the plate to the accessory attachment mechanism, the plurality of apertures being positioned adjacent to the rear edge of the plate;
a pair of lobes being coupled to the plate, each lobe of the pair of lobes having a top side and an bottom side, the bottom side being convexly arcuate between opposing lateral ends of the top side wherein the bottom side is configured to be positioned against the carpet material to dislodge debris from the carpet material, the top side being perpendicular to the plate, the pair of lobes comprising a rigid material wherein the pair of lobes is configured to percussively vibrate against the carpet material to dislodge debris, each lobe of the pair of lobes including:
a top side being perpendicular to the plate, the top side having a front edge, a pair of side edges, and a back edge, the front edge being convexly arcuate between the pair of side edges, each side edge of the pair of side edges being convexly arcuate between the front edge and the back edge, the back edge being convexly arcuate between the pair of side edges, the top side being planar;
a bottom side being coupled to and extending from the top side, the bottom side being convexly arcuate between the pair of side edges of the top side wherein the bottom side is configured to be positioned against the carpet material to dislodge debris from the carpet material; and
a pair of ribs coupling each lobe of the pair of lobes to the plate, the pair of ribs being coplanar with the plate, each rib of the pair of ribs being angled to extend outwardly from the plate and downwardly to the top side of a respective lobe of the pair of lobes wherein the top side of the respective lobe is vertically spaced from the plate, each rib of the pair of ribs being positioned on a respective opposing plate lateral edge of the pair of opposing plate lateral edges of the plate wherein the pair of lobes are spaced from each other across the plate, each rib of the pair of ribs being perpendicular to the top side of the respective lobe of the pair of lobes, each rib of the pair of ribs including:
a rib lateral edge being positioned on the respective opposing plate lateral edge of the pair of opposing plate lateral edges of the plate;
a rib lower edge being coupled to and extending outwardly from the rib lateral edge, the rib lower edge being coupled to the top side of the respective lobe wherein the rib extends upwardly from the top side of the lobe, the rib lower edge being perpendicular to the rib lateral edge; and
a rib upper edge being coupled to and extending from the rib lateral edge, the rib upper edge being angled to extend outwardly from the rib lateral edge and downwardly to intersect with the rib lower edge on the top side of the respective lobe wherein the rib defines a triangular shape.
